(19) United States
(12) Patent Application Publication
(10) Pub. No.: US 2010/0002130 A1
(43) Pub. Date: Jan. 7, 2010

(54) Image processing apparatus and method

(75) Inventor: Kazunori Kamio, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/459,619

(22) Filed: Jul. 2, 2009

(30) Foreign Application Priority Data
Jul. 7, 2008 (JP) P2008-176514

(51) Int. Cl. H04N 7/015

(52) U.S. Cl. 348/441; 348/E07.004

(57) ABSTRACT

An image processing apparatus includes an input image processor configured to perform image processing on a received first image as first sub-pixels of a second image having a resolution higher than a resolution of the first image; at least one sub-pixel generator configured to generate, by shifting a phase of the first image, different sub-pixels that are different from the first sub-pixels of the second image; at least one sub-pixel image processor configured to perform image processing on the different sub-pixels generated by the at least one sub-pixel generator; and an output unit configured to output the first sub-pixels that have been subjected to the image processing by the input image processor and the different sub-pixels that have been subjected to the image processing by the at least one sub-pixel image processor, as the second image, to a subsequent stage.

### BACKGROUND OF THE INVENTION

1. Field of the Invention

The present invention relates to an image processing apparatus and method, and more particularly, to an image processing apparatus and method capable of performing image processing at high resolution with a simple configuration at low cost.

2. Description of the Invention

In order to realize image processing at a resolution higher than high definition (HD) (1920×1080/60 Hz), it is necessary, in terms of processing speed, to perform processing in a parallel manner.

For example, Japanese Unexamined Patent Application Publication Nos. 2005-346639 and 2001-154993 disclose techniques in which image processing is performed in a parallel manner by region division of an image.

However, in these techniques, errors might occur in a boundary portion in spatial image processing. In addition, in the case of providing an overlap area and performing processing, redundant memories and redundant processing are necessary for the overlap area.

As techniques in which handling of errors in a boundary portion and redundancies in an overlap area is taken into consideration, techniques are disclosed in Japanese Unexamined Patent Application Publication Nos. 2004-184457 and 2006-243144 in which one frame is divided into a plurality of sub-frames, coordinates are assigned to the plurality of sub-frames, image processing is performed while the assigned coordinates are maintained, and the plurality of sub-frames are combined on the basis of the coordinates.

### SUMMARY OF THE INVENTION

However, in the above-mentioned techniques for dividing one frame into a plurality of sub-frames and assigning coordinates to the plurality of sub-frames, it is necessary to calculate coordinates, maintain the coordinates, and combine the plurality of sub-frames. Hence, an expensive frame memory is necessary.

It is desirable to allow image processing to be performed at high resolution with a simple configuration at low cost.

According to an embodiment of the present invention, there is provided an image processing apparatus including input image processing means for performing image processing on a received first image as first sub-pixels of a second image having a resolution higher than a resolution of the first image; at least one sub-pixel generating means for generating, by shifting a phase of the first image, different sub-pixels that are different from the first sub-pixels of the second image; at least one sub-pixel image processing means for performing image processing on the different sub-pixels generated by the at least one sub-pixel generating means; and output means for outputting the first sub-pixels that have been subjected to the image processing by the input image processing means and the different sub-pixels that have been subjected to the image processing by the at least one sub-pixel image processing means, as the second image, to a subsequent stage.

The at least one sub-pixel generating means may include a plurality of sub-pixel generating means and the at least one sub-pixel image processing means may include a plurality of sub-pixel image processing means.

The output means may include line memories in which the first sub-pixels that have been subjected to the image processing by the input image processing means and the different sub-pixels that have been subjected to the image processing by the plurality of sub-pixel image processing means are accumulated. The output means may sequentially select the first sub-pixels and the different sub-pixels accumulated in the line memories and output the selected first sub-pixels and different sub-pixels in a predetermined order to the subsequent stage.

The plurality of sub-pixel generating means may include first sub-pixel generating means for generating, by shifting the phase of the first image to the left by 0.5 pixels, second sub-pixels of the second image; second sub-pixel generating means for generating, by shifting the phase of the first image downward by 0.5 pixels, third sub-pixels of the second image; and third sub-pixel generating means for generating, by shifting the phase of the first image to the left by 0.5 pixels and downward by 0.5 pixels, fourth sub-pixels of the second image. The plurality of sub-pixel image processing means may include first sub-pixel image processing means for performing image processing on the second sub-pixels generated by the first sub-pixel generating means; second sub-pixel image processing means for performing image processing on the third sub-pixels generated by the second sub-pixel generating means; and third sub-pixel image processing means for performing image processing on the fourth sub-pixels generated by the third sub-pixel generating means.

According to an embodiment of the present invention, there is provided an image processing method performed in an image processing apparatus including the steps of performing image processing on a received first image as sub-pixels of a second image having a resolution higher than a resolution of the first image; generating, by shifting a phase of the first image, different sub-pixels that are different from the sub-pixels of the second image; performing image processing on the generated different sub-pixels; and outputting the sub-pixels that have been subjected to the image processing and the different sub-pixels that have been subjected to the image processing, as the second image, to a subsequent stage.

According to an embodiment of the present invention, image processing is performed on a received first image as sub-pixels of a second image having a resolution higher than a resolution of the first image. Different sub-pixels that are different from the sub-pixels of the second image are generated by shifting a phase of the first image. Image processing is performed on the generated different sub-pixels. The sub-pixels that have been subjected to the image processing and the different sub-pixels that have been subjected to the image processing are output, as the second image, to a subsequent stage.

According to an embodiment of the present invention, images can be displayed at high resolution. In addition, according to an embodiment of the present invention, image processing at high resolution can be performed with a simple configuration at low cost.

### BRIEF DESCRIPTION OF THE DRAWINGS

FIG. 1 is a block diagram showing an example of the configuration of an image display system according to an embodiment of the present invention;

FIG. 2 illustrates sub-pixel images;

FIG. 3 is a flowchart of an image process performed by an image processing apparatus shown in FIG. 1;

FIG. 4 is a block diagram showing an example of the configuration of a signal output unit shown in FIG. 1;

FIG. 5 illustrates processing performed by the signal output unit shown in FIG. 4; and

FIG. 6 is a block diagram showing another example of the configuration of the image processing apparatus shown in FIG. 1.

### DESCRIPTION OF THE PREFERRED EMBODIMENTS

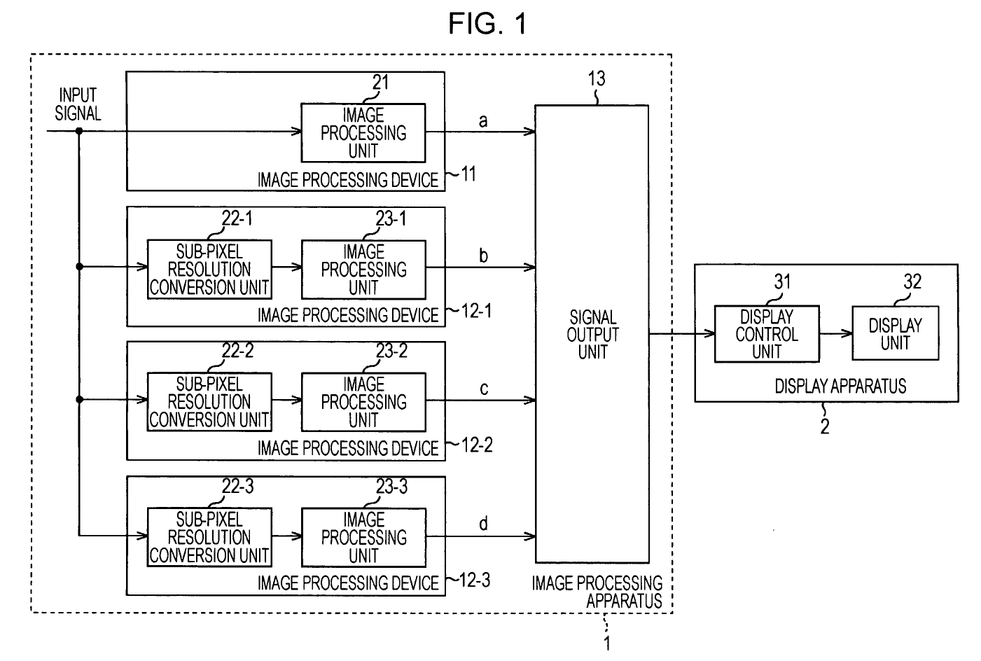

FIG. 1 is a block diagram showing an example of the configuration of an image display system according to an embodiment of the present invention.

The image display system shown in FIG. 1 has a configuration in which a display apparatus 2 is connected to an image processing apparatus 1. The image processing apparatus 1 includes an image processing device 11, image processing devices 12-1 to 12-3, and a signal output unit 13. The image processing apparatus 1 converts an HD image (1920×1080/60 Hz) into a 4K image (3840×2160/60 Hz), performs predetermined image processing on the obtained image, and outputs the processed image to the display apparatus 2.

In the image processing apparatus 1, sub-pixel images are generated by shifting the phase of an HD image, and predetermined image processing is performed on the sub-pixel images in a parallel manner by four image processing devices. Then, four sub-pixel images that have been subjected to the predetermined image processing are output as a 4K image to the display apparatus 2.

The image processing device 11 includes an image processing large scale integrated (LSI) circuit including an image processing unit 21. The image processing devices 12-1 to 12-3 include image processing LSI circuits including sub-pixel resolution conversion units 22-1 to 22-3 and image processing units 23-1 to 23-3, respectively. The image processing device 11 and the image processing devices 12-1 to 12-3 receive input signals (in this case, HD image signals) from the preceding stage (not illustrated).

The image processing unit 21 performs predetermined image processing on a received HD image as a sub-pixel image a of a 4K image. The image processing unit 21 outputs a signal of the sub-pixel image a that has been subjected to the predetermined image processing to the signal output unit 13.

The sub-pixel resolution conversion unit 22-1 calculates a position that is shifted to the left by 0.5 pixels from the position of a received HD image, and generates an image (a sub-pixel image b of a 4K image) at the position, which is shifted to the left by 0.5 pixels from the position of the received HD image. The sub-pixel resolution conversion unit 22-1 performs predetermined resolution conversion on the generated sub-pixel image b, and outputs the processed sub-pixel image b to the image processing unit 23-1. The image processing unit 23-1 performs predetermined image processing on the sub-pixel image b of the 4K image, and outputs a signal of the sub-pixel image b that has been subjected to the predetermined image processing to the signal output unit 13.

The sub-pixel resolution conversion unit 22-2 calculates a position that is shifted downward by 0.5 pixels from the position of a received HD image, and generates an image (a sub-pixel image c of a 4K image) at the position, which is shifted downward by 0.5 pixels from the position of the received HD image. The sub-pixel resolution conversion unit 22-2 performs predetermined resolution conversion on the generated sub-pixel image c, and outputs the processed sub-pixel image c to the image processing unit 23-2. The image processing unit 23-2 performs predetermined image processing on the sub-pixel image c of the 4K image, and outputs a signal of the sub-pixel image c that has been subjected to the predetermined image processing to the signal output unit 13.

The sub-pixel resolution conversion unit 22-3 calculates a position that is shifted to the left by 0.5 pixels and downward by 0.5 pixels from the position of a received HD image, and generates an image (a sub-pixel image d of a 4K image) at the position, which is shifted to the left by 0.5 pixels and downward by 0.5 pixels from the position of the received HD image. The sub-pixel resolution conversion unit 22-3 performs predetermined resolution conversion on the generated sub-pixel image d, and outputs the processed sub-pixel image d to the image processing unit 23-3. The image processing unit 23-3 performs predetermined image processing on the sub-pixel image d of the 4K image, and outputs a signal of the sub-pixel image d that has been subjected to the predetermined image processing to the signal output unit 13.

The signal output unit 13 outputs in a predetermined order, to a display control unit 31, the signals received from the image processing devices 11 and 12-1 to 12-3, in such a manner that the sub-pixel image a from the image processing device 11, the sub-pixel image b from the image processing device 12-1, the sub-pixel image c from the image processing device 12-2, and the sub-pixel image d from the image processing device 12-3 are displayed as a 4K image on a display unit 32.

The display apparatus 2 includes the display control unit 31 and the display unit 32. The display apparatus 2 receives a 4K image from the image processing apparatus 1 and displays the 4K image on the display unit 32.

The display control unit 31 includes, for example, a panel driver. The display control unit 31 causes the display unit 32 to display a 4K image in accordance with a signal of the 4K image received from the image processing apparatus 1. The display unit 32 includes, for example, a liquid crystal display (LCD). The display unit 32 displays a 4K image under the control of the display control unit 31.

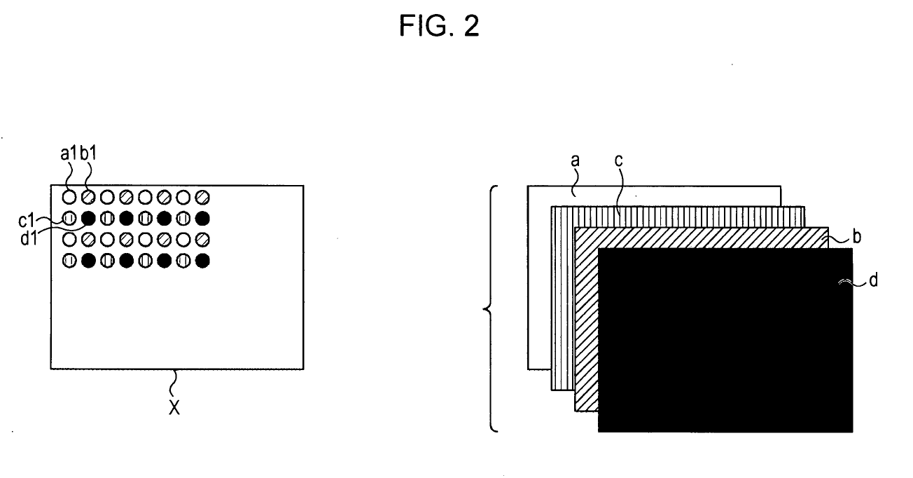

Sub-pixel images will now be described with reference to FIG. 2. In the example shown in FIG. 2, a 4K image X and sub-pixel images a to d are conceptually shown.

The 4K image X is constituted by a plurality of pixels of four types: pixels a1 represented by white circles, pixels b1 represented by circles hatched with oblique lines, pixels c1 represented by circles hatched with vertical lines, and pixels d1 represented by black circles, arranged in order. When the position of the upper-left-most pixel a1 of the 4K image X is set as a reference position, a pixel b1 is located at a position that is shifted to the left by 0.5 pixels from the pixel a1, a pixel c1 is located at a position that is shifted downward by 0.5 pixels from the pixel a1, and a pixel d1 is located at a position that is shifted to the left by 0.5 pixels and downward by 0.5 pixels from the pixel a1.

That is, the 4K image X includes a sub-pixel image (HD image) a constituted by a plurality of pixels a1, a sub-pixel image (HD image) b constituted by a plurality of pixels b1, a sub-pixel image (HD image) c constituted by a plurality of pixels c1, and a sub-pixel image (HD image) d constituted by a plurality of pixels d1.

As described above, in the four image processing devices of the image processing apparatus 1, sub-pixel images a to d are generated from an HD image, where necessary, by phase shifting, image processing is performed on the sub-pixel images a to d in a parallel manner, and the processed sub-pixel images a to d are output in a predetermined order. Accordingly, a 4K image X that has been subjected to image processing can be displayed on the display apparatus 2.

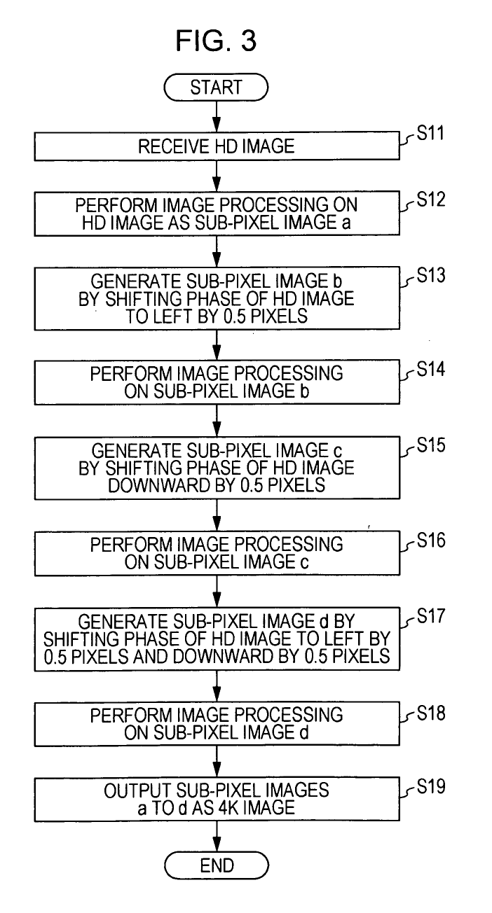

An image process performed by the image processing apparatus 1 will now be described with reference to a flowchart of FIG. 3. Processing of step S12, processing of steps S13 and S14, processing steps S15 and S16, and processing steps S17 and S18 in FIG. 3 are performed in a parallel manner.

In step S11, the image processing device 11 and the image processing devices 12-1 to 12-3 each receive a signal of an HD image from the preceding stage (not illustrated).

In step S12, the image processing unit 21 of the image processing device 11 performs predetermined image processing on the received HD image as a sub-pixel image a of a 4K image.

In step S13, the sub-pixel resolution conversion unit 22-1 of the image processing device 12-1 generates a sub-pixel image b by shifting the phase of the received HD image to the left by 0.5 pixels, performs predetermined resolution conversion on the generated sub-pixel image b, and outputs the processed sub-pixel image b to the image processing unit 23-1. In step S14, the image processing unit 23-1 performs predetermined image processing on the sub-pixel image b of a 4K image, and outputs a signal of the sub-pixel image b that has been subjected to the predetermined image processing to the signal output unit 13.

In step S15, the sub-pixel resolution conversion unit 22-2 of the image processing device 12-2 generates a sub-pixel image c by shifting the phase of the received HD image downward by 0.5 pixels, performs predetermined resolution conversion on the generated sub-pixel image c, and outputs the processed sub-pixel image c to the image processing unit 23-2. In step S16, the image processing unit 23-2 performs predetermined image processing on the sub-pixel image c of a 4K image, and outputs a signal of the sub-pixel image c that has been subjected to the predetermined image processing to the signal output unit 13.

In step S17, the sub-pixel resolution conversion unit 22-3 of the image processing device 12-3 generates a sub-pixel image d by shifting the phase of the received HD image to the left by 0.5 pixels and downward by 0.5 pixels, performs predetermined resolution conversion on the generated sub-pixel image d, and outputs the processed sub-pixel image d to the image processing unit 23-3. In step S18, the image processing unit 23-3 performs predetermined image processing on the sub-pixel image d of a 4K image, and outputs a signal of the sub-pixel image d that has been subjected to the predetermined image processing to the signal output unit 13.

The image processing of steps S12, S14, S16, and S18 will now be explained.

Sub-pixel images of a 4K image, which are generated from an HD image, are input to the image processing unit 21 and the image processing units 23-1 to 23-3. These sub-pixel images are signals of an HD image. Thus, the image processing unit 21 and the image processing units 23-1 to 23-3 are capable of performing image processing for the sub-pixel images at a processing speed that is similar to the processing speed of image processing for an HD image.

In addition, also in terms of the bandwidth (fineness) of an image signal, although a sub-pixel image is part of a 4K image, the sub-pixel image is obtained by enlarging an HD image and a high-frequency signal having a 1 on/1 off configuration or the like in a normal 4K image is not input. Thus, a sampling theorem can be met, and a spatial filter can be used in a manner similar to that for an HD image.

In step S19, the signal output unit 13 outputs the sub-pixel images a to d as a 4K image to the display control unit 31 of the display apparatus 2.

In accordance with this, the display control unit 31 controls the display unit 32 to display the 4K image in accordance with the signal of the 4K image received from the image processing apparatus 1, and the 4K image is displayed on the display unit 32.

As described above, sub-pixel images of an image (4K image) to be output are generated by shifting the phase of a received image (HD image) where necessary, resolution conversion and image processing are performed on the sub-pixel images in a parallel manner, and a 4K image is output.

Consequently, image processing utilizing spatial information and three-dimensional (spatial direction and temporal direction) image processing, as well as image processing on a pixel-to-pixel basis, can be achieved. That is, since an image processing device of the related art can be used, image processing at a resolution higher than high definition can be performed with a simple configuration at low cost.

In addition, resolution conversion and image processing can be performed without regard to combining processing for divided regions in a boundary process necessary for image processing employing region division of the related art.

Furthermore, it is not necessary to perform preprocessing for a received image and coordinate calculation, which are necessary for image processing employing sub-frame division of the related art. Therefore, since a memory for storing image data is unnecessary, cost reduction can be achieved.

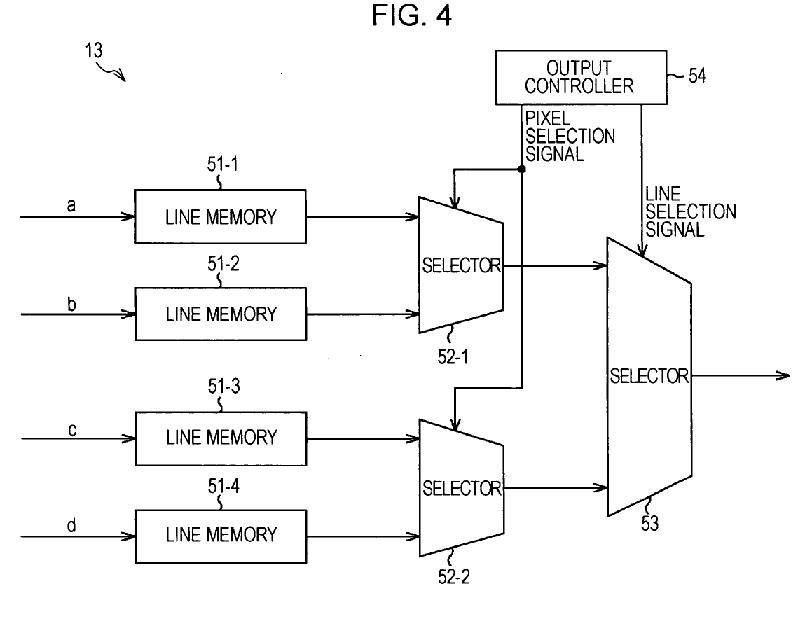

Next, processing of step S19 shown in FIG. 3 for outputting sub-pixel images as a 4K image will be described. FIG. 4 is a block diagram showing an example of the configuration of the signal output unit 13 shown in FIG. 1 for performing the above-described processing in an embodiment.

In the example shown in FIG. 4, the signal output unit 13 includes line memories 51-1 to 51-4, selectors 52-1 and 52-2, a selector 53, and an output controller 54.

The line memory 51-1 stores pixels a1 for one line of the sub-pixel image a received from the image processing device 11. The line memory 51-1 outputs the stored pixels a1 for one line to the selector 52-1 in a predetermined order.

The line memory 51-2 stores pixels b1 for one line of the sub-pixel image b received from the image processing device 12-1. The line memory 51-2 outputs the stored pixels b1 for one line to the selector 52-1 in a predetermined order.

The line memory 51-3 stores pixels c1 for one line of the sub-pixel image c received from the image processing device 12-2. The line memory 51-3 outputs the stored pixels c1 for one line to the selector 52-2 in a predetermined order.

The line memory 51-4 stores pixels d1 for one line of the sub-pixel image d received from the image processing device 12-3. The line memory 51-4 outputs the stored pixels d1 for one line to the selector 52-2 in a predetermined order.

In the following description, in a case where it is not necessary to discriminate among the line memories 51-1 to 51-4, the line memories 51-1 to 51-4 may be referred to as line memories 51.

A pixel selection signal output from the output controller 54 is input to each of the selectors 52-1 and 52-2. When receiving a pixel selection signal (odd) from the output controller 54, the selector 52-1 selects pixels a1 constituting the sub-pixel image a received from the line memory 51-1, and outputs the selected pixels a1 to the selector 53. When receiving a pixel selection signal (even) from the output controller 54, the selector 52-1 selects pixels b1 constituting the sub-pixel image b received from the line memory 51-2, and outputs the selected pixels b1 to the selector 53.

When receiving a pixel selection signal (odd) from the output controller 54, the selector 52-2 selects pixels c1 constituting the sub-pixel image c received from the line memory 51-3, and outputs the selected pixels c1 to the selector 53. When receiving a pixel selection signal (even) from the output controller 54, the selector 52-2 selects pixels d1 constituting the sub-pixel image d received from the line memory 51-4, and outputs the selected pixels d1 to the selector 53.

A line selection signal output from the output controller 54 is input to the selector 53. When receiving a line selection signal (odd) from the output controller 54, the selector 53 selects pixels from the selector 52-1 (that is, the pixels a1 or b1), and outputs the selected pixels to the display control unit 31. When receiving a line selection signal (even) from the output controller 54, the selector 53 selects pixels from the selector 52-2 (that is, the pixels c1 or d1), and outputs the selected pixels to the display control unit 31.

The output controller 54 generates a pixel selection signal and a line selection signal under the display control of the display control unit 31 of the display apparatus 2.

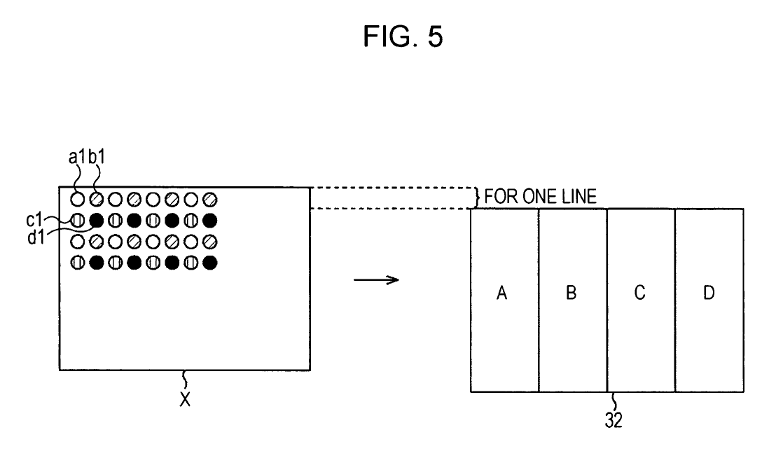

For example, as shown in FIG. 5, the display control unit 31 of the display apparatus 2 divides a display area of the display unit 32 into four regions (regions A to D), and controls display of the regions A to D in order from top to bottom.

Thus, for example, when pixels for the uppermost line of a 4K image are accumulated in the line memories 51-1 and 51-2, the output controller 54 outputs a pixel selection signal (odd) and a line selection signal (odd) to the selector 52-1 and the selector 53 so that pixels a1 corresponding to upper left portions of the regions A to D are output from the line memory 51-1. Next, the output controller 54 outputs a pixel selection signal (even) and a line selection signal (odd) to the selector 52-1 and the selector 53 so that pixels b1 corresponding to pixels on the right-hand side next to the pixels a1 in the regions A to D are output from the line memory 51-2.

In accordance with this, pixels a1 in the regions A to D are sequentially output in order from the selector 53. Then, pixels b1 in the regions A to D are sequentially output in order. By repeating the above-described processing for one line, the uppermost line in each of the regions A to D of the display unit 32 is displayed under the control of the display control unit 31.

Similarly, for example, when pixels for the second uppermost line of the 4K image are accumulated in the line memories 51-3 and 51-4, the output controller 54 outputs a pixel selection signal (odd) and a line selection signal (even) to the selector 52-2 and the selector 53 so that pixels c1 corresponding to pixels immediately below the pixels a1 in the regions A to D are output from the line memory 51-3. Next, the output controller 54 outputs a pixel selection signal (even) and a line selection signal (even) to the selector 52-2 and the selector 53 so that pixels d1 corresponding to pixels on the right-hand side next to the pixels c1 in the regions A to D are output from the line memory 51-4.

In accordance with this, pixels c1 in the regions A to D are sequentially output in order from the selector 53. Then, pixels d1 in the regions A to D are sequentially output in order. By repeating the above-described processing for one line, the second uppermost line in each of the regions A to D of the display unit 32 is displayed under the control of the display control unit 31.

As described above, image signals are output in a predetermined order by using the line memories 51. Thus, four sub-pixel images a to d can be displayed as a 4K image on the display unit 32.

That is, for example, in the case of the display apparatus 2 in which data are loaded in order from the top, no frame memory is necessary. In a case where line memories for one line are provided, four sub-pixel images a to d can be displayed as a 4K image on the display unit 32. Hence, such processing can be achieved with a simple configuration at low cost.

An example in which an HD image (1920×1080/60 Hz) is converted into a 4K image (3840×2160/60 Hz) has been described above. However, a phase-shifted image can be generated on a sub-pixel-to-sub-pixel basis, not with a magnification by integer multiples but with a desired magnification.

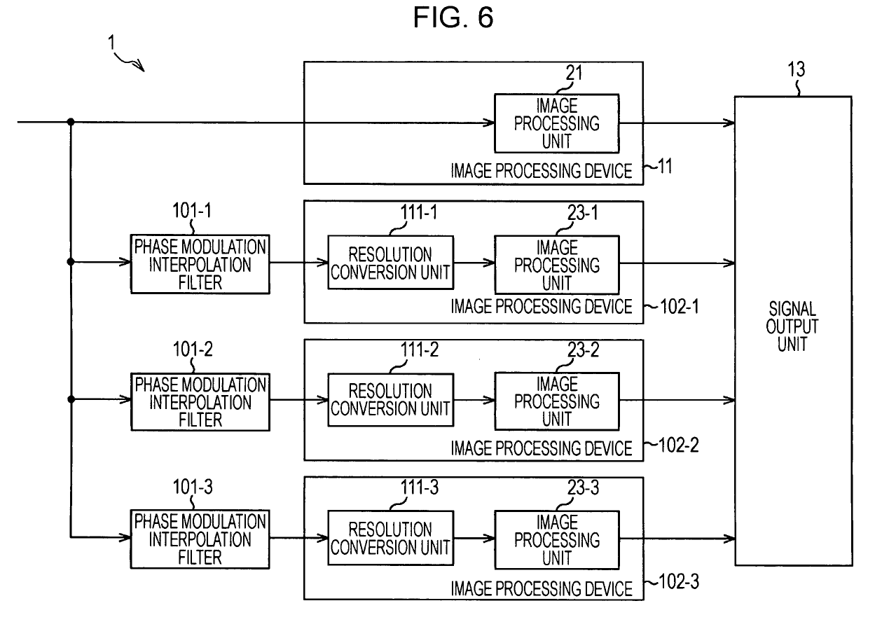

Image processing devices that are not capable of generating a phase-shifted image exist. FIG. 6 shows an example of the configuration of the image processing apparatus 1 including image processing devices that are not capable of generating a phase-shifted image.

The image processing apparatus 1 shown in FIG. 6 is the same as the image processing apparatus 1 shown in FIG. 1 in that the image processing device 11 and the signal output unit 13 are provided. However, the image processing apparatus 1 shown in FIG. 6 differs from the image processing apparatus 1 shown in FIG. 1 in that phase modulation interpolation filters 101-1 to 101-3 are further provided and the image processing devices 12-1 to 12-3 are replaced with image processing devices 102-1 to 102-3.

That is, the image processing devices 102-1 to 102-3 include resolution conversion units 111-1 to 111-3 that are not capable of generating a phase-shifted image; and the image processing units 23-1 to 23-3, which are also provided in the image processing devices 12-1 to 12-3 shown in FIG. 1.

In the case of the image processing apparatus 1 shown in FIG. 6, the image processing device 11 and the phase modulation interpolation filters 101-1 to 101-3 receive input signals from the preceding stage (not illustrated).

The phase modulation interpolation filter 101-1 calculates a position that is shifted to the left by 0.5 pixels from the position of a received HD image, and generates an image at the position, which is shifted to the left by 0.5 pixels from the position of the received HD image. The phase modulation interpolation filter 101-1 outputs the generated image as a sub-pixel image b of a 4K image to the resolution conversion unit 111-1. The resolution conversion unit 111-1 performs predetermined resolution conversion on the sub-pixel image b, and outputs the processed sub-pixel image b to the image processing unit 23-1.

The phase modulation interpolation filter 101-2 calculates a position that is shifted downward by 0.5 pixels from the position of a received HD image, and generates an image at the position, which is shifted downward by 0.5 pixels from the position of the received HD image. The phase modulation interpolation filter 101-2 outputs the generated image as a sub-pixel image c of a 4K image to the resolution conversion unit 111-2. The resolution conversion unit 111-2 performs predetermined resolution conversion on the sub-pixel image c, and outputs the processed sub-pixel image c to the image processing unit 23-2.

The phase modulation interpolation filter 101-3 calculates a position that is shifted to the left by 0.5 pixels and downward by 0.5 pixels from the position of a received HD image, and generates an image at the position, which is shifted to the left by 0.5 pixels and downward by 0.5 pixels from the position of the received HD image. The phase modulation interpolation filter 101-3 outputs the generated image as a sub-pixel image d of a 4K image to the resolution conversion unit 111-3. The resolution conversion unit 111-3 performs predetermined resolution conversion on the sub-pixel image d, and outputs the processed sub-pixel image d to the image processing unit 23-3.

Consequently, in a case where an image processing device that is not capable of generating a phase-shifted image is used, processing equivalent to that in the case of the image processing apparatus 1 shown in FIG. 1 can be achieved with a simple configuration in which phase modulation interpolation filters are provided in the preceding stage.

As described above, in the image processing apparatus 1, sub-pixel images of an image with a resolution higher than that of a received image are generated from the received image, resolution conversion and image processing are performed on the generated sub-pixel images, and the processed sub-pixel images are output as an image with high resolution. Hence, image processing at high resolution can be performed with a simple configuration at low cost. In addition, images can be displayed at high resolution.

In this description, the term “system” refers to the entire equipment constituted by a plurality of apparatuses.

The present invention is not limited to any one of the foregoing embodiments. Various changes can be made to the present invention without departing from the scope of the present invention.

The present application contains subject matter related to that disclosed in Japanese Priority Patent Application JP 2008-176514 filed in the Japan Patent Office on Jul. 7, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
input image processing means for performing image processing on a received first image as first sub-pixels of a second image having a resolution higher than a resolution of the first image;
at least one sub-pixel generating means for generating, by shifting a phase of the first image, different sub-pixels that are different from the first sub-pixels of the second image;
at least one sub-pixel image processing means for performing image processing on the different sub-pixels generated by the at least one sub-pixel generating means; and
output means for outputting the first sub-pixels that have been subjected to the image processing by the input image processing means and the different sub-pixels that have been subjected to the image processing by the at least one sub-pixel image processing means, as the second image, to a subsequent stage.

2. The image processing apparatus according to claim 1, wherein the at least one sub-pixel generating means comprises a plurality of sub-pixel generating means and the at least one sub-pixel image processing means comprises a plurality of sub-pixel image processing means.

3. The image processing apparatus according to claim 2,
wherein the output means includes line memories in which the first sub-pixels that have been subjected to the image processing by the input image processing means and the different sub-pixels that have been subjected to the image processing by the plurality of sub-pixel image processing means are accumulated, and
wherein the output means sequentially selects the first sub-pixels and the different sub-pixels accumulated in the line memories and outputs the selected first sub-pixels and different sub-pixels in a predetermined order to the subsequent stage.

4. The image processing apparatus according to claim 2,
wherein the plurality of sub-pixel generating means include
first sub-pixel generating means for generating, by shifting the phase of the first image to the left by 0.5 pixels, second sub-pixels of the second image,
second sub-pixel generating means for generating, by shifting the phase of the first image downward by 0.5 pixels, third sub-pixels of the second image, and
third sub-pixel generating means for generating, by shifting the phase of the first image to the left by 0.5 pixels and downward by 0.5 pixels, fourth sub-pixels of the second image, and
wherein the plurality of sub-pixel image processing means include
first sub-pixel image processing means for performing image processing on the second sub-pixels generated by the first sub-pixel generating means,
second sub-pixel image processing means for performing image processing on the third sub-pixels generated by the second sub-pixel generating means, and
third sub-pixel image processing means for performing image processing on the fourth sub-pixels generated by the third sub-pixel generating means.

5. An image processing method performed in an image processing apparatus, the method comprising the steps of:
performing image processing on a received first image as sub-pixels of a second image having a resolution higher than a resolution of the first image;
generating, by shifting a phase of the first image, different sub-pixels that are different from the sub-pixels of the second image;
performing image processing on the generated different sub-pixels; and
outputting the sub-pixels that have been subjected to the image processing and the different sub-pixels that have been subjected to the image processing, as the second image, to a subsequent stage.

6. An image processing apparatus comprising:
an input image processor configured to perform image processing on a received first image as first sub-pixels of a second image having a resolution higher than a resolution of the first image;
at least one sub-pixel generator configured to generate, by shifting a phase of the first image, different sub-pixels that are different from the first sub-pixels of the second image;
at least one sub-pixel image processor configured to perform image processing on the different sub-pixels generated by the at least one sub-pixel generator; and
an output unit configured to output the first sub-pixels that have been subjected to the image processing by the input image processor and the different sub-pixels that have been subjected to the image processing by the at least one sub-pixel image processor, as the second image, to a subsequent stage.
